(19) United States
(12) Patent Application Publication
(10) Pub. No.: US 2011/0303664 A1
(43) Pub. Date: Dec. 15, 2011

(54) Trash can fogger

(76) Inventor: Brian Nichols, Apple Valley, CA (US)

(21) Appl. No.: 13/134,367

(22) Filed: Jun. 6, 2011

Related U.S. Application Data
(60) Provisional application No. 61/396,911, filed on Jun. 4, 2010.

(51) Int. Cl. B65F 7/00

(52) U.S. Cl. 220/87.2; 220/908.2

(57) ABSTRACT

The Trash Can Fogger is a deodorizer and disinfectant that infuses a refuse container with a refreshing, sanitary substance when impacted on the inner surface of the unit. This product is packaged in a pressurized metal canister, which releases a measured portion of its contents in response to applied pressure. A safety tab removed prior to use is incorporated into the design of the dispenser nozzle, thus preventing accidental release of the spray. In addition, encircling the top of the canister is a raised rim, which prevents the dispenser nozzle from coming into contact with other objects, should the canister be knocked over or fall to the ground. The exterior of the Trash Can Fogger boasts the product logo, while important safety information and instructions for use are boldly imprinted on the back of the unit. Inside, a pressurized vapor made up of non-toxic, environmentally safe disinfectant and deodorizing solution, upon release, linger in the air, attaching to airborne bacteria and odor molecules.

### CLAIM OF PRIORITY

This patent application claims priority under 35 USC 119 (e) (1) from U.S. Provisional Patent Application Ser. No. 61/396,911 filed Jun. 4, 2010, of common inventorship herewith entitled, “Trash Can Fogger.”

### FIELD OF THE INVENTION

The present invention pertains to the field of air freshener devices, and more specifically to the field of aerosol disinfectant and deodorizer devices.

### BACKGROUND OF THE INVENTION

The prior art has put forth several designs for deodorizer devices. Among these are:

U.S. Pat. No. 3,955,706 to William King Whitaker describes a deodorized waste container with a built in deodorizer or air freshener. The air freshener can be an integral part of the interior wall(s) of the waste container or affixed to the container wall(s) by an adhesive.

U.S. Pat. No. 4,874,129 to Alfred J. DiSapio, et al describes a multi-layered multi-laminate sustained release device capable of releasing fragrances, colognes, and perfumes, at a controlled rate for a prolonged period of time and having a first layer of a pressure sensitive adhesive.

U.S. Pat. No. 6,554,151 to James Brennan describes a waste receptacle combined with an air freshener connected to the waste receptacle. Removal of a trash bag from the waste receptacle will cause a flow of air through the opening and air freshener to freshen the interior of the waste receptacle.

None of these prior art references describe the present invention.

### SUMMARY OF THE INVENTION

It is an object of the present invention to provide an aerosol disinfectant and deodorizer device for use in trash cans and garbage cans.

### BRIEF DESCRIPTION OF THE DRAWINGS

FIG. 1 is an elevational angled perspective view of the device of the present invention.

FIG. 2 is an elevational angled perspective view of the device of the present invention in its horizontal position.

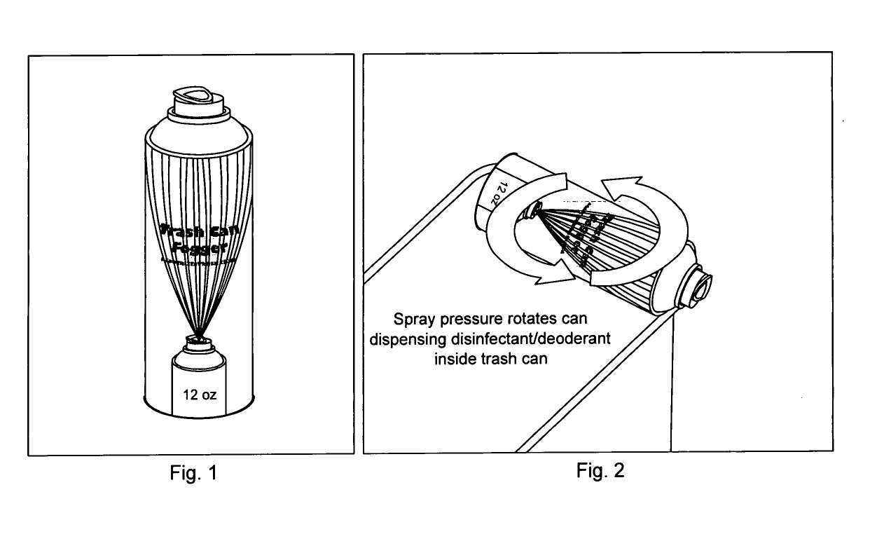

### DETAILED DESCRIPTION OF THE INVENTION

For most people, the daily disposal of garbage is a necessary fact of life. Empty milk jugs, food containers, orange and banana peels, scraps of paper, and soda pop bottles are just a few of the items tossed in the trash every day. By far, the United States leads the world in garbage disposal. In fact, according to a recent study compiled by the Environmental Protection Agency (EPA), the average American discards an astonishing 4.4 pounds of trash daily, with 40% of this garbage being produced in the kitchen. It is safe to say that almost everyone produces garbage. Because of this, the vast majority of households are equipped with at least one, or several, garbage cans. Produced in a variety of sizes, garbage cans are usually found in kitchens, bathrooms, bedrooms, laundry rooms and garages, offering consumers an easy means of collecting waste. Many homes also contain large, outside receptacles, used for collecting the household garbage for later disposal by waste management services. Along with recycling bins, these containers are normally positioned on the side of the home close to a back door, where refuse can be conveniently disposed during the day or at night. Many businesses rely on outdoor garbage containers, as well. Large, metal dumpsters are usually required for the massive amounts of refuse generated by businesses each day.

As useful and necessary as outside garbage receptacles are, their use does present a drawback. Particularly, lingering odors and associated germs and bacteria are still a problem consumers face even with outdoor cans and dumpsters. As the waste is continuously exposed to the elements, strong odors can permeate an entire receptacle before it is full enough to be discarded. While garbage can lids can help alleviate the spread of these odors, they do nothing to control the growth of germs and bacteria which results from remnants of garbage and spilled liquids in the garbage canister. Further, consumers still encounter unpleasant smells when opening the container to discard more garbage. For businesses such as restaurants, the odor challenge is even more daunting. As discarded food and liquids sit in a dumpster until they are emptied by a sanitation service, the sheer volume of the waste inside quickly results in pungent, spoiled odors enveloping the area surrounding the receptacle. Unfortunately, due to these examples, the intended sanitary purpose of outdoor garbage cans and dumpsters is sometimes compromised.

The present invention, hereinafter referred as the Trash Can Fogger, is a practical product invention that offers a convenient solution to the aforementioned problems. Simply stated, the Trash Can Fogger is a deodorizer/disinfectant that infuses a refuse container with a refreshing, sanitary substance when impacted on the inner surface of the unit. This product is similar in function to traditional total release foggers. As such, the Trash Can Fogger is packaged in a pressurized metal canister. A safety tab removed prior to use is incorporated into the design of the dispenser nozzle, thus preventing accidental release of the spray. In addition, encircling the top of the canister is a raised rim which prevents the dispenser nozzle from coming into contact with other objects, should the canister be knocked over or fall to the ground. The exterior of the Trash Can Fogger boasts the product logo, while important safety information and instructions for use are boldly imprinted on the back of the unit. Inside, a pressurized vapor made up of non-toxic, environmentally safe disinfectant and deodorizing solution, upon release, linger in the air, attaching to airborne bacteria and odor molecules. The Trash Can Fogger is made available in a variety of fragrances, such as refreshing citrus, floral, or outdoor scents, to name a few options. Deodorizing air fresheners to be affixed to the interior of a trash can are included for sale with or alongside the Trash Can Fogger. These air fresheners are produced in both rectangular and square shaped versions and are secured to the canister via a self affixing adhesive backing.

Use and application of the Trash Can Fogger is very simple and straightforward. First, the user removes a unit from its packaging. Opening the lid of the dumpster or household receptacle, the user then releases the Trash Can Fogger's tab, in turn releasing the inner disinfectant and deodorizer solution. The user then closes the lid to contain the vapor, allowing it eradicate the odors and bacteria that emanate from the garbage. As a result, pungent smells are stopped in their tracks, infusing the container with a more pleasant scent and therefore keeping the outside air clean. As a result, when the receptacle is approached and the lid is opened, the user encounters a more welcome scent.

There are several significant benefits and advantages associated with this creative product invention. Foremost, the Trash Can Fogger offers consumers a disinfectant/deodorizer that provides a convenient, hassle-free means of keeping an outdoor trash can or dumpster, as well as the surrounding area, odor and germ free. A total release spray that houses an efficient, germ-fighting disinfectant, as well as an odor absorbing deodorizer, use of the Trash Can Fogger results in the eradication of the toughest garbage odors and bacteria. Universal in construction and application, the Trash Can Fogger is well suited for use in containers ranging from thirty-gallon plastic cans to large, industrial sized dumpsters. As such, homeowners, professional cleaning services, and office establishments all appreciate the many advantages this useful product affords. The Trash Can Fogger is especially beneficial to restaurants and other dining establishments, as it eliminates the dreadful odors that can detract from an appetizing atmosphere as well as raise objections during Board of Health inspections.

An innovative product invention, the Trash Can Fogger offers consumers a more user-friendly means of garbage collection and management. Simple to use, this functional product proves a valuable accessory in any home or business establishment.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An aerosol disinfectant and deodorizer device, comprising a deodorizer and disinfectant device that infuses a refuse container with a refreshing, sanitary substance when impacted on the inner surface of the unit, wherein the deodorizer and disinfectant is packaged in a pressurized metal canister comprising a safety tab removed prior to use incorporated into the design of the dispenser nozzle, thus preventing accidental release of the spray.

2. The device of claim 1 further comprising a raised rim which prevents the dispenser nozzle from coming into contact with other objects encircling the top of the canister in the event the canister be knocked over or fall to the ground.

3. The device of claim 2 further comprising markings on the exterior of the canister identifying the product and including important safety information and instructions for use.

4. The device of claim 2 wherein the canister contains a pressurized vapor made up of non-toxic, environmentally safe disinfectant and deodorizing solution.

5. The device of claim 4 wherein the vapor, when released, lingers in the air, and attaches to airborne bacteria and odor molecules.

6. The device of claim 4 wherein the vapor is made available in a variety of fragrances, such as refreshing citrus, floral, or outdoor scents, to name a few options.

7. The device of claim 2 further comprising deodorizing air fresheners to be affixed to the interior of a trash included for sale with the device, wherein these air fresheners are produced in both rectangular and square shaped versions and are secured to the canister by means of self affixing adhesive backing.
